(19) United States
(12) Patent Application Publication
(10) Pub. No.: US 2025/0293956 A1
(43) Pub. Date: Sep. 18, 2025

(54) METHOD AND SYSTEM FOR DISCOVERING APPLICATION SERVICES IN FEDERATION OF OPERATORS IN WIRELESS NETWORK

(71) Applicant: Samsung Electronics Co., Ltd., Suwon-si, Gyeonggi-do (KR)

(72) Inventors: Sapan Pramodkumar SHAH, Bangalore (IN); Narendranath Durga TANGUDU, Bangalore (IN); Basavaraj Jayawant PATTAN, Bangalore (IN); Hyesung KIM, Suwon-si (KR)

(21) Appl. No.: 18/860,998

(22) PCT Filed: Apr. 21, 2023
(86) PCT No.: PCT/KR2023/005489

§ 371 Date: Oct. 28, 2024

(30) Foreign Application Priority Data
Apr. 29, 2022 (IN) 202241025358
Apr. 7, 2023 (IN) 2022 41025358

(51) Int. Cl. H04L 41/50; H04L 67/55; H04W 12/06; H04W 60/00

(52) U.S. Cl. CPC H04L 41/5058; H04L 67/55; H04W 12/06; H04W 60/00

(57) ABSTRACT

Embodiments herein disclose a method and system for discovering application services in federation of operators in a wireless network. The method performed by a first edge configuration server (ECS) repository of a first ECS, includes a registered edge application server (EAS) publish request or a registered EAS unpublish request from a first edge enabler server (EES), authorizing the registered EAS publish request or the registered EAS unpublish request upon receiving the registered EAS publish request or the registered EAS unpublish request from the first EES, sending a registered EAS publish response or a registered EAS unpublish response to the first EES when the registered EAS publish request or the registered EAS unpublish request is authorized.

### CROSS-REFERENCE TO RELATED APPLICATION(S)

This application is a U.S. National Stage application under 35 U.S.C. § 371 of an International application number PCT/KR2023/005489, filed on Apr. 21, 2023, which is based on and claims priority of an Indian Provisional patent application No. 20/224,1025358, filed on Apr. 29, 2022, in the Indian Intellectual Property Office, and of an Indian Complete patent application No. 202241025358, filed on Apr. 7, 2023, in the Indian Intellectual Property Office, the disclosure of each of which is incorporated by reference herein in its entirety.

### TECHNICAL FIELD

The present disclosure relates to a wireless communication, and more particularly to a method and a system for discovering application services in federation of operators in a wireless network.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In general, as specified in operator platform telco edge requirements, operators in Fifth-Generation (5G) have a significant opportunity to monetize capabilities of networks. The operators need to make their assets and capabilities consistently available across the networks. Hence, a collaboration of operators called an Operator Platform (OP) is defined to provide a federated edge computing infrastructure to give access to application providers for larger service area. The federation of operators allows one operator for example a lead operator to expose capabilities of the other operators for example partner operators to third party service providers or own subscribers.

### DISCLOSURE OF INVENTION

### Technical Problem

The principal object of the embodiments herein is to provide a method and a system for discovering application services in federation of operators in a wireless network. The method includes subscribing by an Edge Configuration Server (ECS) repository of a first ECS to an ECS repository of a second ECS to receive EAS information deployed on shared edge resources.

Another object of the embodiments herein is to update a registered Edge Application Server (EAS) information by the ECS repository of the second ECS to the ECS repository of the first ECS, when a list of registered and allowed EAS on the ECS repository of the second ECS changes.

Another object of the embodiments herein is to send a notification by the ECS repository of the second ECS to the ECS repository of the first ECS when a new EAS is registered or the registered EAS information is updated.

Another object of the embodiments herein is to send an application discovery request by the first EES to the second EES to receive application profiles efficiently.

Therefore, the proposed method supports an edge node sharing service and federation of operators in an effective manner.

### Solution to Problem

Accordingly the embodiments herein disclose a method for discovering application services in federation of operators in a wireless network. The method includes receiving, by a first edge configuration server (ECS) repository of a first ECS, a registered edge application server (EAS) publish request or a registered EAS unpublish request from a first edge enabler server (EES), authorizing, by the first ECS repository, the registered EAS publish request or the registered EAS unpublish request upon receiving the registered EAS publish request or the registered EAS unpublish request from the first EES, and sending, by the first ECS repository, a registered EAS publish response or a registered EAS unpublish response to the first EES when the registered EAS publish request or the registered EAS unpublish request is authorized.

Accordingly the embodiments herein disclose a method for discovering application services in federation of operators in a wireless network. The method includes receiving, by a second ECS repository of a second ECS, a registered EAS information subscription request to receive registered EAS information from a first ECS repository of a first ECS, determining, by the second ECS repository, whether the first ECS repository is authorized to receive the registered EAS information or not upon receiving the registered EAS information subscription request from the first ECS repository, and performing, by the second ECS repository, one of: sending a registered EAS information subscription success response along with a subscription identity to the first ECS repository when the first ECS repository is authorized to receive the registered EAS information, or sending a failure response to the first ECS repository when the first ECS repository is not authorized to receive the registered EAS information.

Accordingly the embodiments herein disclose a first edge configuration server (ECS) for discovering application services in federation of operators in a wireless network. The first ECS includes a memory, a communicator and a controller coupled with the memory and the communicator. The controller is configured to: receive a registered Edge Application Server (EAS) publish request or a registered EAS unpublish request from a first edge enabler server (EES), authorize the registered EAS publish request or the registered EAS unpublish request upon receiving the registered EAS publish request or the registered EAS unpublish request from the first EES, and send a registered EAS publish response or a registered EAS unpublish response to the first EES when the registered EAS publish request or the registered EAS unpublish request is authorized.

Accordingly the embodiments herein disclose a second edge configuration server (ECS) for discovering application services in federation of operators in a wireless network. The second ECS includes a memory, a communicator, and a controller coupled with the memory and the communicator. The controller is configured to: receive a registered EAS information subscription request to send registered EAS information from a first edge configuration server (ECS) repository of a first ECS, determine whether the first ECS repository is authorized to receive the registered EAS information or not upon receiving the registered EAS information subscription request from the first ECS repository, and perform one of: send a registered EAS information subscription success response along with a subscription identity to the first ECS repository when the first ECS repository is authorized to receive the registered EAS information, or send a failure response to the first ECS repository when the first ECS repository is not authorized to receive the registered EAS information.

Accordingly the embodiments herein disclose a method for discovering application services in federation of operators in a wireless network. The method includes receiving, by an ECS repository of a first ECS, a registered EAS publish request or a registered EAS unpublish request from a first EES, authorizing the registered EAS publish request or the registered EAS unpublish request upon receiving the registered EAS publish request or the registered EAS unpublish request from the first EES, and sending a registered EAS publish response or a registered EAS unpublish response to the first EES when the registered EAS publish request or the registered EAS unpublish request is authorized.

In an embodiment, the method includes sending, by the ECS repository of the first ECS, a registered EAS information subscription request to receive registered EAS information to an ECS repository of a second ECS, determining, by the ECS repository of the second ECS, whether the ECS repository of the first ECS is authorized to receive the registered EAS information or not upon receiving the registered EAS information subscription request from the ECS repository of the first ECS, and performing, by the ECS repository of the second ECS, one of: (i) sending a registered EAS information subscription success response along with a subscription identity to the ECS repository of the first ECS when the ECS repository of the first ECS is authorized to receive the registered EAS information, and (ii) sending a failure response to the ECS repository of the first ECS when the ECS repository of the first ECS is not authorized to receive the registered EAS information.

In an embodiment, the registered EAS information subscription request includes an edge computing service provider (ECSP) identifier, an ECS identifier, security parameters, and a federation identifier.

In an embodiment, the method includes determining, by the ECS repository of the second ECS, a change of list of registered and allowed EAS on the ECS repository of the second ECS, wherein the change includes one of: a new EAS is registered, EAS registration is updated, the registered EAS is deregistered, the new EAS is published or already published EAS is unpublished, and sending, by the ECS repository of the second ECS, a notification to the ECS repository of the first ECS when the list of registered and allowed EAS changes, where the notification includes information regarding the registered and allowed EAS for edge node sharing service between a first ECSP and a second ECSP, an EAS profile, an EAS identifier (ID) and an EAS geographical service. The method includes storing, by the ECS repository of the first ECS, the information received with the notification for EAS discovery or receiving registered EAS information from the ECS repository of the second ECS.

In an embodiment, the method includes sending, by the ECS repository of the first ECS, a registered EAS information request for fetching the registered EAS information to the ECS repository of the second ECS, determining, by the ECS repository of the second ECS, whether the ECS repository of the first ECS is authorized to receive the registered EAS information or not upon receiving the registered EAS information request from the ECS repository of the first ECS, and sending, by the ECS repository of the second ECS, a registered EAS information response to the ECS repository of the first ECS when the ECS repository of the first ECS is authorized to receive the registered EAS information.

In an embodiment, the registered EAS information request is sent from the ECS repository of the first ECS to the ECS repository of the second ECS, and the registered EAS information response is sent from the ECS repository of the second ECS to the ECS repository of the first ECS through an interface connecting the ECS repository of the first ECS and the ECS repository of the second ECS.

In an embodiment, the registered EAS information response includes a list of EAS IDs which are registered within the ECS repository of the first ECS and shared to the ECS repository of the second ECS, and EES information of a second ECSP.

In an embodiment, the method includes receiving, by the first EES, a EAS discovery request from an Edge Enabler client (EEC), determining, by the first EES, a use of an edge service from the second ECSP upon receiving the EAS discovery request from the EES, sending, by the first EES, the EAS discovery request to a second EES based on the use of the edge service, validating, by the second EES, the EAS discovery request received from the first EES based on a service level agreement between a first ECSP and a second ECSP, sending, by the second EES, a EAS discovery response to the first EES upon successful validation of the EAS discovery request, and sending, by the first EES, the EAS discovery response including a discovered candidate EAS to the EEC.

In an embodiment, the EAS discovery response received by the first EES from the second EES includes a list of EASs and a list of EAS profiles.

Accordingly the embodiments herein disclose a system for discovering application services in federation of operators in the wireless network. The system includes a first OP and a second OP. Each OP includes an EES and an ECS. A first ECS includes a memory, a processor coupled to the memory, a communicator coupled to the memory and the processor, and an application management controller coupled to the memory, the processor and the communicator. The application management controller configured to receive the registered EAS publish request or the registered EAS unpublish request from the first EES, authorize the registered EAS publish request or the registered EAS unpublish request upon receiving the registered EAS publish request or the registered EAS unpublish request from the first EES, and send the registered EAS publish response or the registered EAS unpublish response to the first EES when the registered EAS publish request or the registered EAS unpublish request is authorized.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the invention thereof, and the embodiments herein include all such modifications.

### BRIEF DESCRIPTION OF DRAWINGS

These and other features, aspects, and advantages of the present invention is illustrated in the accompanying drawings, throughout which like reference letters indicate corresponding parts in the various figures. The embodiments herein will be better understood from the following description with reference to the drawings, in which:

FIG. 1 is an example illustrating a scenario of providing an edge node sharing service in federation of operators for edge computing, according to the prior arts;

FIG. 2 is a block diagram of a ECS, according to the embodiments as disclosed herein;

FIG. 3 is an example illustrating a step-by step procedure to publish or unpublish registered EAS information from the first EES to the ECS repository of the first ECS, according to the embodiments as disclosed herein;

FIG. 4a is a block diagram illustrating a connection between the ECS repository of the first ECS and the first EES, according to the embodiments as disclosed herein;

FIG. 4b is a block diagram illustrating a connection between the ECS repository of the first ECS and an ECS repository of a second ECS, according to the embodiments as disclosed herein;

FIG. 5 is an example illustrating a step-by step procedure to subscribe-notify for registered EAS information, according to the embodiments as disclosed herein;

FIG. 6 is an example illustrating a step-by step procedure for sending registered EAS information response to the ECS repository of the first ECS, according to the embodiments as disclosed herein; and

FIG. 7 is an example illustrating a step-by step procedure for sending EAS discovery response to an EEC, according to the embodiments as disclosed herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Accordingly the embodiments herein disclose a method for discovering application services in federation of operators in a wireless network. The method includes receiving, by an ECS repository of a first ECS, a registered EAS publish request or a registered EAS unpublish request from the first EES, authorizing the registered EAS publish request or the registered EAS unpublish request upon receiving the registered EAS publish request or the registered EAS unpublish request from the first EES, and sending a registered EAS publish response or a registered EAS unpublish response to the first EES when the registered EAS publish request or the registered EAS unpublish request is authorized.

One of an important service of the federation is an Edge Node sharing service. Edge node sharing is a scenario where the OP decides to provide the application from the Edge nodes of a partner OP (where the application is available), when serving requests are originated from own User Equipment (UE).

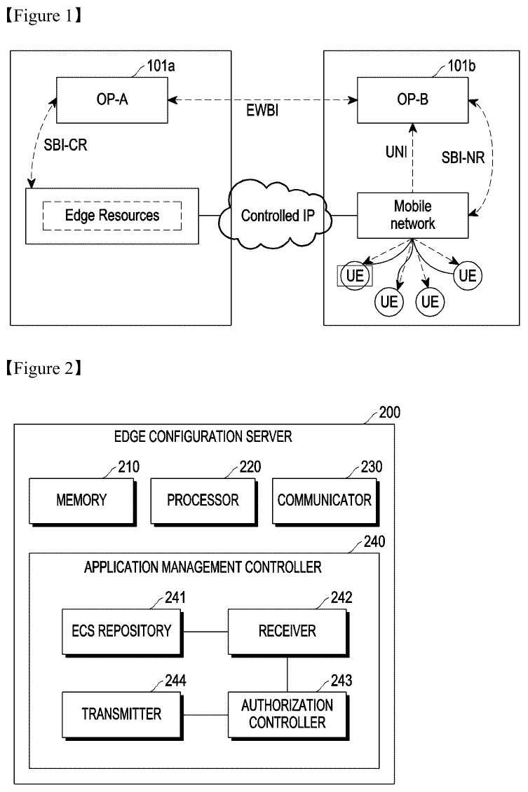

For example, FIG. 1 illustrates the importance of Edge Node sharing service in federation of the operators for edge computing. Considering a scenario where two operators, for example an operator-A (OP-A) 101a and an operator-B (OP-B) 101b have deployed edge network in a city. However, a specific application for example a game server is deployed by the operator-B 101b in to shared resources of the operator-A 101a, and hosted in the edge network provided by the operator-A 101a. Without federation, all subscribers of the operator-B 101b do not have access to the specific application while using the edge network. The federation of the operator-A 101a and the operator-B 101b allows the operator-B 101b to expose all applications to all the subscribers of the operator-B 101b based on a service level agreement between the operator-A 101a and the operator-B 101b.

For federation of the operator, the OPs require to exchange and maintain types of resources offered to each other. In order to enable federation, publishing of the application and availability zone information has to be supported to enable the specific applications to be served from a Leading OP's Edge Cloud. In conventional Third Generation Partnership Project (3GPP) defined Edge Enabler Layer (EEL), the EEL exposes Application Programming Interfaces (APIs) to support capabilities like service provisioning, registration, application server discovery, capability exposure to Application Server (AS) and support for service continuity. However, the EEL layer does not support functionalities of federation and specifically the edge node sharing service. Without the support for federation, the operators cannot provide efficient service to their customer everywhere.

Thus, it is required to enhance the EEL to enable Edge Node Sharing service support in order to enable federation of operators, and to provide support for discovering applications from the partner operator to the lead operator to provide services to subscribers by addressing the above mentioned disadvantages or other shortcomings or at least provide a useful alternative.

Accordingly the embodiments herein disclose a system for discovering application services in federation of operators in the wireless network. The system includes a first OP and a second OP. Each OP includes an edge enabler server (EES) and an edge configuration server (ECS). A first ECS includes a memory, a processor coupled to the memory, a communicator coupled to the memory and the processor, and an application management controller coupled to the memory, the processor and the communicator. The application management controller configured to receive the registered EAS publish request or the registered EAS unpublish request from the first EES, authorize the registered EAS publish request or the registered EAS unpublish request upon receiving the registered EAS publish request or the registered EAS unpublish request from the first EES, and send the registered EAS publish response or the registered EAS unpublish response to the first EES when the registered EAS publish request or the registered EAS unpublish request is authorized.

Conventionally, considering a scenario where two operators in a city, for example an operator-1 and an operator-2 deploys edge network. However, a specific application, for example a game server is deployed by the operator-B 101b in to the shared resources of the operator-A 101a, and hosted in the edge network provided by the operator-2. Without federation, all subscribers of the operator-1 do not have access to the game server while using the edge network. The federation of the operator-1 and the operator-2 allows the operator-1 to expose all applications to all the subscribers of the operator-1 based on a service level agreement.

For federation of the operators, OPs require to exchange and maintain types of resources offered to each other. In order to enable federation service, publishing of the specific application and availability zone information has to be supported to enable specific applications to be served from a leading OP's edge cloud in the following scenarios:
In a roaming scenario where local breakout (i.e. data plane access to Edge Cloud resources in visited network) is not available, the applications need to be served from a home OP for consumption by roaming UEs; and
In a non-roaming scenario where the OP needs to allow own UEs, the consumption of applications published by the Partner OP is served from that partner's edge cloud.

The conventional methods and systems provide an EEL which exposes APIs to support capabilities like service provisioning, registration, application server discovery, capability exposure to an AS and a support for service continuity. Application Clients (ACs) in an UE locates and connects with most suitable EAS available in an Edge Data Network (EDN), using the capabilities provided by the EEL. However, the conventional methods and systems fail to enhance the EEL to enable Edge Node Sharing service support in order to enable federation of operators in an effective manner.

Unlike the conventional methods and systems, the proposed method enhances the EEL to enable Edge Node Sharing service support in order to enable federation of operators. The proposed method enables subscription by the ECS repository of the first ECS to the ECS repository of the second ECS to receive EAS information deployed on shared edge resources. The proposed method updates the registered EAS information by the ECS repository of the second ECS to the ECS repository of the first ECS, when a list of registered and allowed EAS on the ECS repository of the second ECS changes. Further, the proposed method sends a notification by the ECS repository of the second ECS to the ECS repository of the first ECS when the new EAS is registered or the registered EAS information is updated. The proposed method also sends an application discovery request by the first EES to the second EES to receive application profiles efficiently.

Referring now to the drawings and more particularly to FIGS. 2 through 7, where similar reference characters denote corresponding features consistently throughout the figure, these are shown preferred embodiments.

FIG. 2 is a block diagram of an ECS 200, according to the embodiments as disclosed herein.

Referring to FIG. 2, the ECS 200 may include a memory 210, a processor 220, a communicator 230 and an application management controller 240. The ECS 200 may be a first ECS.

The memory 210 may be configured to store an Edge Computing Service Provider (ECSP) identifier, an ECS identifier, security parameters, and a federation identifier. The memory 210 may include non-volatile storage elements. Examples of such non-volatile storage elements include magnetic hard discs, optical discs, floppy discs, flash memories, or forms of electrically programmable memories (EPROM) or electrically erasable and programmable (EEPROM) memories. In an embodiment, the memory 210, in some examples, may be considered as a non-transitory storage medium. The term “non-transitory” indicates that the storage medium is not embodied in a carrier wave or a propagated signal. However, the term “non-transitory” should not be interpreted that the memory 210 is non-movable. In an embodiment, the memory 210 may be configured to store larger amounts of information. In certain examples, a non-transitory storage medium stores data that changes over time (e.g., in Random Access Memory (RAM) or cache).

The processor 220 may include one or a plurality of processors. The one or the plurality of processors are a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 220 may include multiple cores and may be configured to determine the ECSP identifier, the ECS identifier, the security parameters, and the federation identifier stored in the memory 210.

In an embodiment, the communicator 230 may include an electronic circuit specific to a standard that enables wired or wireless communication. The communicator 230 may be configured to communicate internally between internal hardware components of the ECS 200 and with external devices via one or more networks.

In an embodiment, the application management controller 240 may include at least one of an ECS repository 241, a receiver 242, an authorization controller 243 or a transmitter 244.

In an embodiment, the ECS repository 241 may store information to be used in procedures for example in an EAS discovery or to receive a registered EAS information request from own ECS for example the first ECS 200 or from another ECS for example a second ECS. The ECS repository 241 may also send a registered EAS information response to the own ECS for example the first ECS 200 or to another ECS (not shown).

In an embodiment, the receiver 242 may be configured to receive one of a registered EAS publish or a registered EAS unpublish request, a registered EAS information subscription request, a registered EAS information request for fetching the registered EAS information, or an EAS discovery request from the ECS repository 241.

In an embodiment, the authorization controller 243 may be configured to authorize the registered EAS publish request, the registered EAS unpublish request, the registered EAS information subscription request, the registered EAS information request for fetching the registered EAS information, or the EAS discovery request upon receiving the registered EAS publish request, the registered EAS unpublish request, the registered EAS information subscription request, the registered EAS information request for fetching the registered EAS information, or the EAS discovery request from the ECS repository 241.

In an embodiment, the transmitter 244 may be configured to send one of a registered EAS publish response, a registered EAS unpublish response, a registered EAS information subscription response, a registered EAS information response, or an EAS discovery response from the ECS repository (241) to another ECS when the corresponding request is authorized.

The application management controller 240 may be implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

At least one of the plurality of modules/components of the application management controller 240 may be implemented through an AI model. A function associated with the AI model may be performed through the memory 210 and the processor 220. The one or a plurality of processors may control the processing of the input data in accordance with a predefined operating rule or the AI model stored in the non-volatile memory and the volatile memory. The predefined operating rule or artificial intelligence model may be provided through training or learning.

Here, being provided through learning means that, by applying a learning process to a plurality of learning data, a predefined operating rule or AI model of a desired characteristic is made. The learning is performed in a device itself in which AI according to an embodiment is performed, and/or may be implemented through a separate server/system.

The AI model consists of a plurality of neural network layers. Each layer has a plurality of weight values and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning process is a method for training a predetermined target device (for example, a robot) using a plurality of learning data to cause, allow, or control the target device to make a determination or prediction. Examples of learning processes include, but are not limited to, supervised learning, unsupervised learning, semi-supervised learning, or reinforcement learning.

Although the FIG. 2 show the hardware elements of the ECS 200 but it is to be understood that other embodiments are not limited thereon. In other embodiments, the ECS 200 may include less or more number of elements. Further, the labels or names of the elements are used only for illustrative purpose and does not limit the scope of the invention. One or more components can be combined together to perform same or substantially similar function.

The various actions, acts, blocks, steps, or the like in the method may be performed in the order presented, in a different order or simultaneously. Further, in some embodiments, some of the actions, acts, blocks, steps, or the like may be omitted, added, modified, skipped, or the like without departing from the scope of the invention.

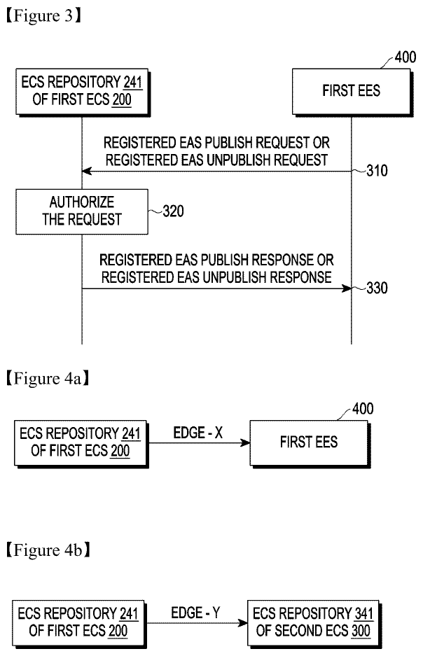

FIG. 3 is an example illustrating a step-by step procedure to publish or unpublish registered EAS information from the first EES 400 to the ECS repository 241 of the first ECS 200, according to the embodiments as disclosed herein.

Referring to FIG. 3, considering a scenario where an application, for example an EAS is deployed in a partner OP's edge data network. The first EES 400 and the first ECS 200 may be entities within a first OP.

At operation 310, based on a service level agreement between a first Edge Computing Service Provider (ECSP-1) and a second ECSP-2 and also based on an EAS registration status, the first EES 400 may send the registered EAS information publish or unpublish request to the ECS repository 241 of the first ECS 200. The request may include registered and allowed EAS for edge node sharing service between the ECSP-1 and the ECSP-2, and an EAS profile along with a service area and an endpoint address.

At operation 320, the ECS repository 241 of the first ECS 200 may check whether the first EES 400 is authorized to publish or unpublish a registered EAS list or not based on the service level agreement between the ECSP-1 and the ECSP-2.

At operation 330, the ECS repository 241 of the first ECS 200 may store the EAS information and sends the registered EAS information publish or unpublish response to the first EES 400.

In an embodiment, the registered EAS information may be published by a second ECS to the ECS repository 241 of the first ECS 200.

FIG. 4a is a block diagram illustrating connection between the ECS repository 241 of the first ECS 200 and the first EES 400, according to the embodiments as disclosed herein.

Referring to FIG. 4a, an EDGE-X is an interface between an EES (e.g., the first EES 400) and an ECS repository (e.g., the ECS repository 241 of the first ECS 200). The EDGE-X may provide at least one of following functionalities:

a. Publish or unpublish the registered and allowed EAS for edge node sharing service;

b. Subscribe or unsubscribe to receive information related to the registered and allowed EAS for the edge node sharing service from a partner ECSP for example the ECSP-2; and

c. Request to receive the registered and allowed EAS for the edge node sharing service.

FIG. 4b is a block diagram illustrating connection between the ECS repository 241 of the first ECS 200 and an ECS repository 341 of the second ECS 300, according to the embodiments as disclosed herein.

Referring to FIG. 4b, an EDGE-Y is an interface between the repositories of one of: different ECSs (e.g., ECS 200 and ECS 300), different Edge Networks (EDNs) or of different ECSPs or of different Public Land Mobile Network (PLMNs). The EDGE-Y may provide at least one of following functionalities:
a. Publish or unpublish the registered and allowed EAS for the edge node sharing service,
b. Subscribe or unsubscribe to receive information related to the registered and allowed EAS for the edge node sharing service from the partner ECSP, and
c. Request to receive the registered and allowed EAS for the edge node sharing service.

In an embodiment, the registered EAS information request may be sent from the ECS repository 241 of the first ECS 200 to the ECS repository 341 of the second ECS 300, and the registered EAS information response may be sent from the ECS repository 341 of the second ECS 300 to the ECS repository 241 of the first ECS 200 through the interface connecting the ECS repository 241 of the first ECS 200 and the ECS repository 341 of the second ECS 300.

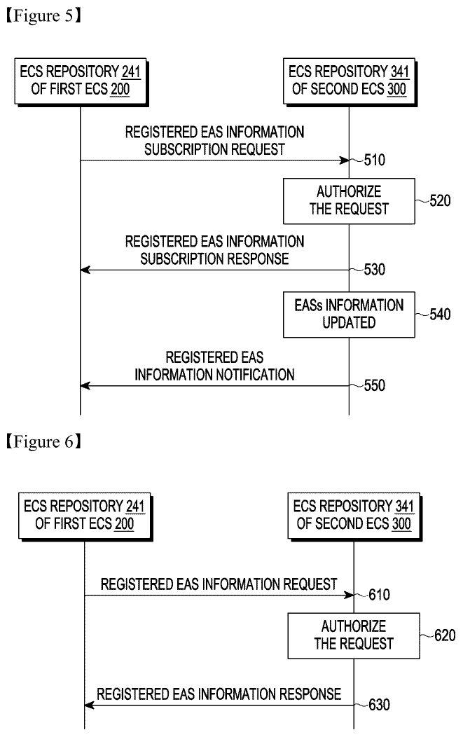

FIG. 5 is an example illustrating a step-by step procedure to subscribe-notify for registered EAS information, according to the embodiments as disclosed herein.

Referring to FIG. 5, at operation 510, based on the service level agreement between the ECSP-1 and the ECSP-2, the ECS repository 241 of the first ECS 200 may send a subscription request to receive the registered EAS information (including the service area) to the ECS repository 341 of the second ECS 300. The request may include but not limited to an ECSP identifier, an ECS identifier and security parameters.

At operation 520, upon receiving the request from the ECS repository 241 of the first ECS 200, the ECS repository 341 of the second ECS 300 may check whether the ECS repository 241 of the first ECS 200 is authorized to receive the registered EAS list or not based on the service level agreement.

At operation 530, the ECS repository 340 of the second ECS 300 may send a subscription response indicating a result of the subscription (success or failure) and a subscription identity (when the subscription result is success) to the ECS repository 241 of the first ECS 200.

At operation 540, the ECS repository 341 of the second ECS 300 may determine a change of list of the registered and allowed EAS on the ECS repository 341 of the second ECS 300. The change may include at least one of: a new EAS is registered, EAS registration is updated, the registered EAS is deregistered, the new EAS is published, or already published EAS is unpublished.

At operation 550, the ECS repository 340 of the second ECS 300 may send a notification to the ECS repository 241 of the first ECS 200, when the list of registered and allowed EAS changes. The notification may include information regarding the registered and allowed EAS for edge node sharing service between the first ECSP and the second ECSP, an EAS identifier (ID) and an EAS geographical service.

Upon receiving the notification, the ECS repository 241 of the first ECS 200 may store the information to be used in other procedures, for example the EAS discovery or for receiving the registered EAS information request.

FIG. 6 is an example illustrating a step-by step procedure for sending a registered EAS information response to the ECS repository 241 of the first ECS 200, according to the embodiments as disclosed herein.

Referring to FIG. 6, the ECS repository 241 of the first ECS 200 may fetch the EAS information from the ECS repository 341 of the second ECS 300 as described below:

At operation 610, the ECS repository 241 of the first ECS 200 may send a registered EAS information request to the ECS repository 341 of the second ECS 300.

At operation 620, the ECS repository 341 of the second ECS 300 may determine whether the ECS repository 241 of the first ECS 200 is authorized to receive the registered EAS information or not upon receiving the registered EAS information request from the ECS repository 241 of the first ECS 200.

At operation 630, the ECS repository 341 of the second ECS 300 may send a registered EAS information response to the ECS repository 241 of the first ECS 200 when the ECS repository 241 of the first ECS 200 is authorized to receive or fetch the registered EAS information.

In a fetch operation, the registered EAS information response from the ECS repository 341 of the second ECS 300 may include a list of EAS IDs which are registered within the first ECS 200 and shared to the second ECS 300, and the EES information of the second ECS 300.

In an embodiment, when the second ECS 300 does not receive the EES information of the first ECS 200 from the published/notified application information, the second ECS 300 may fetch the EES information of the first ECS 200 from the first ECS 200 via the fetch operation. The second ECS 300 fetches the EES information of the first ECS 200 from the first ECS 200 when the EAS IDs and the EES information of the first ECS 200 is not available in the second ECS 300.

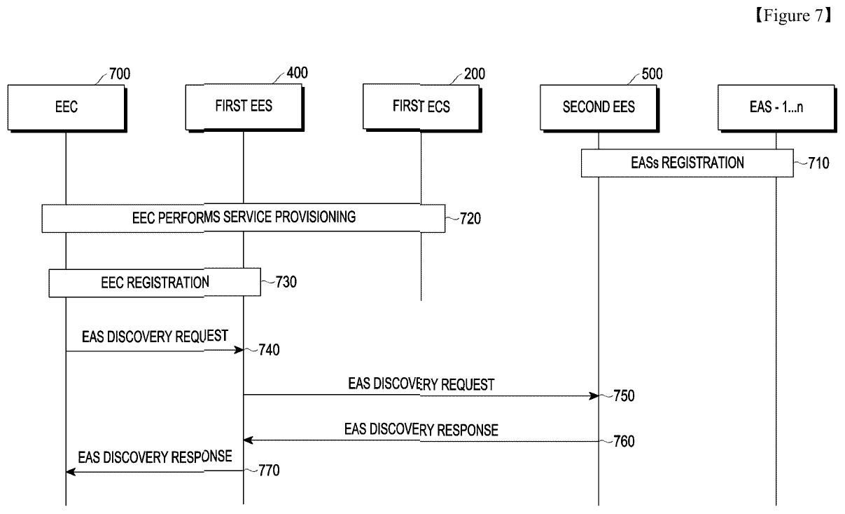

FIG. 7 is an example illustrating a step-by step procedure for sending EAS discovery response to an EEC 700, according to the embodiments as disclosed herein. Referring to FIG. 7, at operation 710, the EAS may be registered in the second EES 500.

At operation 720, the EEC 700 may perform service provisioning with the first EES 400.

At operation 730, the EEC 700 may be registered in the first EES 400 over an EDGE-3 reference point. The EAS may be dynamically instantiated during the EAS discovery processing on the first EES 400 and then registered in the first EES 400.

At operation 740, the EEC 700 may send an EAS discovery request to the first EES 400.

At operation 750, the first EES 400 may determine a use of the edge service from the second ECSP upon receiving the EAS discovery request from the EEC 700. In an embodiment, the first EES 400 may sends the EAS discovery request to the second EES 500 based on the use of the edge service.

At operation 760, the second EES 500 may validate the EAS discovery request received from the first EES 400 based on the service level agreement between the first ECSP and the second ECSP. The second EES 500 may send an EAS discovery response to the first EES 400 upon successful validation of the EAS discovery request.

At operation 770, the first EES 400 may send the EAS discovery response including a discovered candidate EAS to the EEC 700.

Accordingly the embodiments herein disclose a method for discovering application services in federation of operators in a wireless network. The method includes receiving, by a first edge configuration server (ECS) repository of a first ECS, a registered edge application server (EAS) publish request or a registered EAS unpublish request from a first edge enabler server (EES), authorizing, by the first ECS repository, the registered EAS publish request or the registered EAS unpublish request upon receiving the registered EAS publish request or the registered EAS unpublish request from the first EES, and sending, by the first ECS repository, a registered EAS publish response or a registered EAS unpublish response to the first EES when the registered EAS publish request or the registered EAS unpublish request is authorized.

Accordingly the embodiments herein disclose a method for discovering application services in federation of operators in a wireless network. The method includes receiving, by a second ECS repository of a second ECS, a registered EAS information subscription request to receive registered EAS information from a first ECS repository of a first ECS, determining, by the second ECS repository, whether the first ECS repository is authorized to receive the registered EAS information or not upon receiving the registered EAS information subscription request from the first ECS repository, and performing, by the second ECS repository, one of: sending a registered EAS information subscription success response along with a subscription identity to the first ECS repository when the first ECS repository is authorized to receive the registered EAS information, or sending a failure response to the first ECS repository when the first ECS repository is not authorized to receive the registered EAS information.

Accordingly the embodiments herein disclose a first edge configuration server (ECS) for discovering application services in federation of operators in a wireless network. The first ECS includes a memory, a communicator and a controller coupled with the memory and the communicator. The controller is configured to: receive a registered Edge Application Server (EAS) publish request or a registered EAS unpublish request from a first edge enabler server (EES), authorize the registered EAS publish request or the registered EAS unpublish request upon receiving the registered EAS publish request or the registered EAS unpublish request from the first EES, and send a registered EAS publish response or a registered EAS unpublish response to the first EES when the registered EAS publish request or the registered EAS unpublish request is authorized.

Accordingly the embodiments herein disclose a second edge configuration server (ECS) for discovering application services in federation of operators in a wireless network. The second ECS includes a memory, a communicator, and a controller coupled with the memory and the communicator. The controller is configured to: receive a registered EAS information subscription request to send registered EAS information from a first edge configuration server (ECS) repository of a first ECS, determine whether the first ECS repository is authorized to receive the registered EAS information or not upon receiving the registered EAS information subscription request from the first ECS repository, and perform one of: send a registered EAS information subscription success response along with a subscription identity to the first ECS repository when the first ECS repository is authorized to receive the registered EAS information, or send a failure response to the first ECS repository when the first ECS repository is not authorized to receive the registered EAS information.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method for discovering application services in a federation of operators in a wireless network, the method comprising:
receiving, by a first edge configuration server (ECS) repository of a first ECS, a registered edge application server (EAS) publish request or a registered EAS unpublish request from a first edge enabler server (EES);
authorizing, by the first ECS repository, the registered EAS publish request or the registered EAS unpublish request upon receiving the registered EAS publish request or the registered EAS unpublish request from the first EES; and
sending, by the first ECS repository, a registered EAS publish response or a registered EAS unpublish response to the first EES in case that the registered EAS publish request or the registered EAS unpublish request is authorized.

2. The method as claimed in claim 1, wherein the method comprises:
sending, by the first ECS repository, a registered EAS information subscription request to receive registered EAS information to a second ECS repository of a second ECS;
performing, by the first ECS repository, one of:
receiving a registered EAS information subscription success response along with a subscription identity from the second ECS repository in case that the second ECS repository determines that the first ECS repository is authorized to receive the registered EAS information; or
receiving a failure response from the second ECS repository in case that the second ECS repository determines that the first ECS repository is not authorized to receive the registered EAS information;
receiving, by the first ECS repository, a notification in case that a list of registered and allowed EAS is changed on the second ECS repository; and
storing, by the first ECS repository, information received with the notification for EAS discovery on receiving the notification.

3. The method as claimed in claim 2, wherein the registered EAS information subscription request comprises at least one of an edge computing service provider (ECSP) identifier, an ECS identifier, security parameters, or a federation identifier.

4. The method as claimed in claim 3, wherein the method comprises:
sending, by the first ECS repository, a registered EAS information request for fetching the registered EAS information to the second ECS repository; and
receiving, by the first ECS repository, a registered EAS information response from the second ECS repository in case that the second ECS repository determines that the first ECS repository is authorized to receive the registered EAS information.

5. A method for supporting a federation of edge computing service providers (ECSPs) by an edge configuration server (ECS) repository in a wireless network, the method comprising:
receiving, by the ECS repository, a request from an ECS;
determining, by the ECS repository, whether the ECS is authorized or not upon receiving the request from the ECS; and
performing, by the ECS repository, one of:
sending a success response to the ECS in case that the ECS is authorized; or
sending a failure response to the ECS in case that the ECS is not authorized.

6. The method as claimed in claim 5, wherein the request comprises an ECS identifier and security parameters.

7. The method as claimed in claim 5, wherein the method comprises:
determining, by the ECS repository, a change of a list of registered and allowed edge application servers (EASs) on the ECS repository, wherein the change comprises at least one of: a new EAS is registered, EAS registration is updated, the registered EAS is deregistered, the new EAS is published or already published EAS is unpublished; and
sending, by the ECS repository, a notification to the ECS in case that the list of registered and allowed EAS is changed on the ECS repository, wherein the notification comprises information regarding the registered and allowed EAS for edge node sharing service between a first ECSP and a second ECSP, an EAS identifier (ID) and an EAS geographical service.

8. The method as claimed in claim 6, wherein the method comprises:
receiving, by the ECS repository, from the ECS, a registered edge application server (EAS) information request for fetching registered EAS information;
determining, by the ECS repository, whether the ECS is authorized to receive the registered EAS information or not upon receiving the registered EAS information request from the ECS; and
sending, by the ECS repository, a registered EAS information response to the ECS in case that the ECS is authorized to receive the registered EAS information.

9. The method as claimed in claim 8, wherein the registered EAS information request and/or the registered EAS information response is sent through an interface connecting the ECS and the ECS repository.

10. The method as claimed in claim 8, wherein the registered EAS information response comprises a list of EAS IDs which are registered within the ECS and shared to the ECS repository, and edge enabler server (EES) information of a second ECSP.

11. The method as claimed in claim 7, wherein the method comprising:
receiving, by a first edge enabler server (EES), an EAS discovery request from an edge enabler client (EEC);
determining, by the first EES, a use of an edge service from the second ECSP upon receiving the EAS discovery request from the EEC;
sending, by the first EES, the EAS discovery request to a second EES based on the use of the edge service;
validating, by the second EES, the EAS discovery request received from the first EES based on a service level agreement between the first ECSP and the second ECSP;
sending, by the second EES, an EAS discovery response to the first EES upon successful validation of the EAS discovery request; and
sending, by the first EES, the EAS discovery response comprising a discovered candidate EAS to the EEC.

12. The method as claimed in claim 11, wherein the EAS discovery response received by the first EES from the second EES comprises a list of EASs and a list of EAS profiles.

13. A first edge configuration server (ECS) repository for discovering application services in a federation of operators in a wireless network, the first ECS repository comprising:
a memory;
a communicator; and
a processor coupled with the memory and the communicator, and configured to:
receive a registered edge application server (EAS) publish request or a registered EAS unpublish request from a first edge enabler server (EES);
authorize the registered EAS publish request or the registered EAS unpublish request upon receiving the registered EAS publish request or the registered EAS unpublish request from the first EES; and
send a registered EAS publish response or a registered EAS unpublish response to the first EES in case that the registered EAS publish request or the registered EAS unpublish request is authorized.

14. An edge configuration server (ECS) repository for supporting a federation of edge computing service providers (ECSPs) in a wireless network, the ECS repository comprising:
a memory;
a communicator; and
a processor coupled with the memory and the communicator, and configured to:
receive a request from an ECS;
determine whether the ECS is authorized or not upon receiving the request from the ECS; and
perform one of:
send a success response to the ECS in case that the ECS is authorized; or
send a failure response to the ECS in case that the ECS is not authorized.

15. The ECS repository as claimed in claim 14, wherein the ECS repository is further configured to:
determine a change of a list of registered and allowed edge application server (EAS) on the ECS repository, wherein the change comprises at least one of: a new EAS is registered, EAS registration is updated, the registered EAS is deregistered, the new EAS is published or already published EAS is unpublished; and
send a notification to the ECS in case that the list of registered and allowed EAS is changed on the ECS repository, wherein the notification comprises information regarding the registered and allowed EAS for edge node sharing service between a first ECSP and a second ECSP, an EAS identifier (ID) and an EAS geographical service.

16. The method as claimed in claim 6, wherein the request further comprises an ECSP identifier.

17. The ECS repository as claimed in claim 14, wherein the request comprises an ECS identifier and security parameters.

18. The ECS repository as claimed in claim 17, wherein the request further comprises an ECSP identifier.
